(19) United States
(12) Patent Application Publication
(10) Pub. No.: US 2015/0020167 A1
(43) Pub. Date: Jan. 15, 2015

(54) SYSTEM AND METHOD FOR MANAGING FILES

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventors: QI-LONG YU, Shenzhen (CN); TSUNG-JEN CHUANG, New Taipei (TW); JUN ZHANG, Shenzhen (CN); JIAN-JUN ZHOU, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 14/324,931

(22) Filed: Jul. 7, 2014

(30) Foreign Application Priority Data
Jul. 12, 2013 (CN) 2013102925657

(51) Int. Cl. H04L 29/06

(52) U.S. Cl. CPC H04L 63/08; H04L 67/42
USPC 726/4

(57) ABSTRACT

A method is provided for managing files among a cloud server and at least one terminal device. The terminal device stores preprocessed files. The method includes steps of determining a type of one preprocessed file when the terminal device receives a request for opening the preprocessed file. Determining a corresponding software to open the preprocessed file. Generating a control signal including information of the preprocessed file needed to be opened and the determined software, and transmitting the control signal to the cloud server. Determining an authorization status of the terminal device in response to the control signal. Storing a copy of the preprocessed file in a buffer of the cloud server if the terminal device is authorized. Obtaining the determined software in the cloud server according to the control signal. Controlling the determined software to open the copy of the preprocessed file.

### FIELD

The present disclosure relates to file management, and particularly to a system and a method for managing files.

### BACKGROUND

Servers are usually employed for storing confidential files. To ensure the security of internal information, each time a file is stored, an author or a designated user can set an access authority of the file at the server. For example, a user must input a correct username and a password to access the files stored in the server.

### BRIEF DESCRIPTION OF THE DRAWINGS

Implementations of the present disclosure will now should be described, by way of example only, with reference to the following drawings. The modules in the drawings are not necessarily drawn to scale, the emphasis instead being placed upon clearly illustrating the principles of the present disclosure. Moreover, in the drawings, like reference numerals designate corresponding portions throughout the views. The description is not to be considered as limiting the embodiments described herein or the appended claims.

FIG. 1 is a block diagram of an embodiment of a cloud server and a terminal device.

FIG. 2 is a block diagram of an embodiment of a system applied to the cloud server and the terminal device of FIG. 1.

FIG. 3 is a flowchart of an embodiment of a method for managing files.

### DETAILED DESCRIPTION

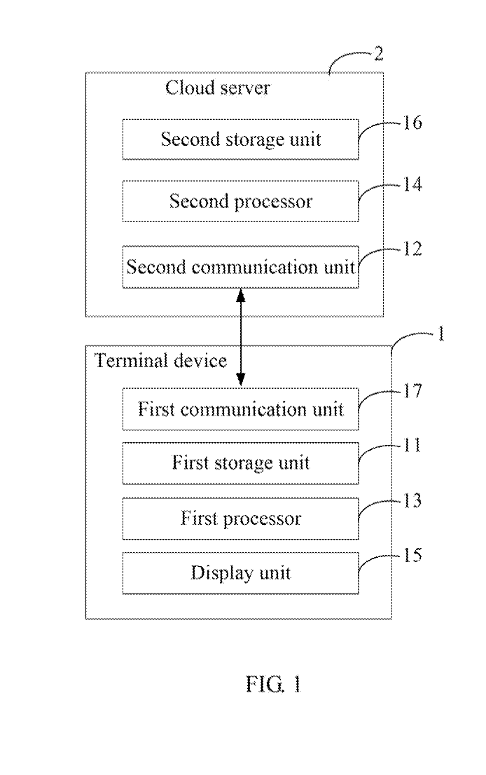

FIG. 1 shows an embodiment of an applied environment of a cloud server 2 and at least one terminal device 1. The terminal device 1 can communicate with the cloud server 2 to transmit data, such as files after being preprocessed (hereinafter “preprocessed files”) stored in the terminal device 1. The preprocessed files can be image files, text files, audio files, or other files after being preprocessed. The preprocessed files can be downloaded to the terminal device 1 from a service provider. In the illustrated embodiment, the terminal device 1 can be a computer.

The terminal device 1 includes a first storage unit 11, a first processor 13, a display unit 15, and a first communication unit 17. The cloud server 2 includes a second communication unit 12, a second processor 14, and a second storage unit 16. The first processor 13 and the second processor 14 can be central processing units, digital processors, or single chips, for example. The types of the first processor 13 and the second processor 14 can be the same or different.

The first storage unit 11 stores the preprocessed files. Corresponding software to open different types of the preprocessed files are only stored in the second storage unit 16 of the cloud server 2, such that the preprocessed files cannot be opened by the terminal device 1 by itself. The first communication unit 17 can connect with the second communication unit 12 to transmit data between the terminal device 1 and the cloud server 2.

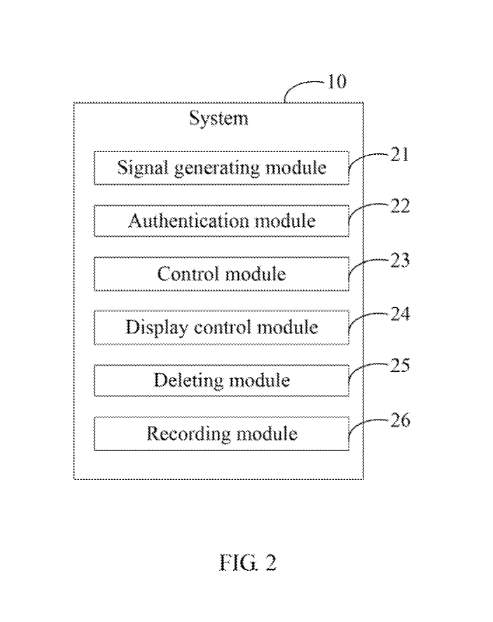

FIG. 2 shows an embodiment of a system 10 employed to manage files between the cloud server and the terminal device. The system 10 includes a number of modules. Some of the modules are executed by the first processor of the terminal device 1, and the other modules are executed by the second processor of the cloud server.

In the illustrated embodiment, the system 10 includes a signal generating module 21, an authentication module 22, a control module 23, a display control module 24, a deleting module 25, and a recording module 26. The signal generating module 21 and the display control module 24 are executed by the first processor of the terminal device 1. The authentication module 22, the control module 23, the deleting module 25, and the recording module 26 are executed by the second processor of the cloud server.

When the terminal device 1 receives a request for opening a preprocessed file, the signal generating module 21 determines the type of the preprocessed file, such as an image file, a text file, an audio file, and so on. The signal generating module 21 then determines a software to open the preprocessed file according to the determined type, generates a control signal including information of the preprocessed file needed to be opened and the determined software to open the preprocessed file, and transmits the control signal to the cloud server 2 to inform the cloud server 2 to open the preprocessed file using the determined software.

The authentication module 22 determines an authorization status of the terminal device 1 in response to the control signal. In the illustrated embodiment, the control signal further includes an internet protocol (IP) address of the terminal device 1. The authentication module 22 determines the authorization status of the terminal device 1 according to the IP address of the terminal device 1.

The control module 23 stores a copy of the preprocessed file into a buffer (not shown) of the cloud server 2 if the terminal device 1 is determined to be authorized by the authentication module 22. The control module 23 further obtains the determined software in the cloud server 2 according to the control signal, and controls the determined software to open the copy of the preprocessed file in the cloud server 2. Otherwise, if the terminal device 1 is determined to be unauthorized by the authentication module 22, the control module 23 performs no actions.

In at least one embodiment, the authentication module 22 can further provide an input interface on the display unit 15 of the terminal device 1 for the user to input identification information if the terminal device 1 is determined to be unauthorized by the authentication module 22, and determines an authorization status of the user according to the input identification information. If the user is determined to be authorized by the authentication module 22, the control module 23 stores the copy of the preprocessed file into the cloud server 2 and obtains the determined software in the cloud server 2 to open the copy of the preprocessed file in the cloud server 2. In the illustrated embodiment, the identification information includes a username and a password. In at least one embodiment, the identification information can be a fingerprint, a voiceprint, or the like.

The display control module 24 controls the terminal device 1 to display an edit interface on the display unit 15 for the user to edit the copy of the preprocessed file.

The control module 23 further saves the copy of the preprocessed file to the cloud server 2 in response to a save command from the terminal device 1, and replaces the preprocessed file stored in the terminal device 1 with the saved copy. In the illustrated embodiment, when at least two terminal devices 1 are coupled with the cloud server 2, an operation authority of each preprocessed file is classified into a number of levels (hereinafter “operation authority levels”) according to different terminal devices 1 and different users. For example, the operation authority levels of a preprocessed file include levels of “read,” “edit,” “print,” and “complete control.” The second storage unit 16 of the cloud server 2 further stores a relationship between the terminal devices 1 and operation authority levels of the preprocessed file, and each terminal device 1 corresponds to one operation authority level of the preprocessed file. The authentication module 22 further determines the operation authority level of the preprocessed file corresponding to the terminal device 1. When the determined operation authority level is “edit” or “complete control,” the control module 23 saves the copy of the preprocessed file in response to the save command.

The deleting module 25 deletes the copy of the preprocessed file stored in the cloud server 2 when the user closes the preprocessed file.

The recording module 26 records information including a time period of using the determined software, an IP address of the terminal device 1, and the input username of the user.

With the above configuration, the cloud server 2 has no need to store the preprocessed files. The cloud server 2 only needs to store the corresponding software to open the preprocessed files stored in the terminal device 1, and obtains the copy of the preprocessed file only when the user opens the preprocessed file and saves the preprocessed file after editing, thus reducing a burden of the cloud server 2.

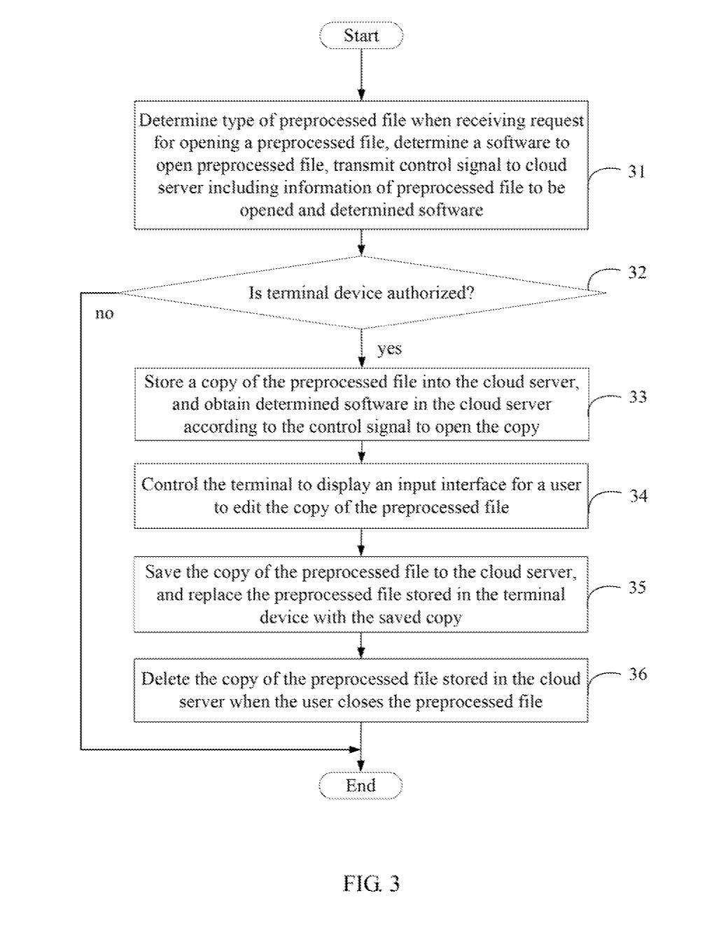

FIG. 3 is a flowchart of an embodiment of a method of managing files.

In 31, the signal generating module determines the type of the preprocessed file when the terminal device receives a request for opening the preprocessed file, determines a software to open the preprocessed file according to the determined type, generates a control signal including information of the preprocessed file needed to be opened and the determined software to open the preprocessed file, and transmits the control signal to the cloud server.

In 32, the authentication module determines an authorization status of the terminal device in response to the control signal, if the terminal device is authorized, the procedure goes to 33; otherwise, the procedure ends.

In 33, the control module stores a copy of the preprocessed file into the buffer of the cloud server, and obtains the determined software in the cloud server according to the control signal to open the copy of the preprocessed file in the cloud server.

In 34, the display control module controls the terminal device to display an edit interface on the display unit for the user to edit the copy of the preprocessed file.

In 35, the control module saves the copy of the preprocessed file to the cloud server in response to a save command from the terminal device, and replaces the preprocessed file stored in the terminal device with the saved copy.

In 36, the deleting module deletes the copy of the preprocessed file stored in the cloud server when the user closes the preprocessed file.

The described embodiments and their advantages will be understood from the foregoing description. It will be apparent that various changes may be made thereto without departing from the scope of the disclosure or sacrificing all of its material advantages, the examples described merely being exemplary embodiments of the present disclosure. The described embodiments are not intended to limit the scope of the following claims.

What is claimed is:

1. A system for managing files among a cloud server and at least one terminal device coupled with the cloud server, the system comprising:
a first storage unit and a first processor comprised in each of the at least one terminal device, the first storage unit for storing preprocessed files;
a second processor comprised in the cloud server; and
a plurality of modules executed by the first processor and the second processor to manage files among the cloud server and the at least one terminal device, the plurality of modules comprising:
a signal generating module executed by the first processor to determine a type of one preprocessed file when the at least one terminal device receives a request for opening the preprocessed file, determine a software to open the preprocessed file according to the determined type, generate a control signal comprising information of the preprocessed file needed to be opened and the determined software to open the preprocessed file, and transmit the control signal to the cloud server;
an authentication module executed by the second processor to determine an authorization status of the at least one terminal device in response to the control signal; and
a control module executed by the second processor to store a copy of the preprocessed file in a buffer of the cloud server if the at least one terminal device is determined to be authorized by the authentication module, obtain the determined software in the cloud server according to the control signal, and control the determined software to open the copy of the preprocessed file.

2. The system of claim 1, wherein the control signal comprises an IP address of the at least one terminal device, and the authentication module is configured to determine the authorization status of the at least one terminal device according to the IP address of the at least one terminal device.

3. The system of claim 1, wherein the authentication module is further configured to provide an input interface on a display unit of the at least one terminal device for a user to input identification information if the at least one terminal device is determined to be unauthorized by the authentication module, and determine an authorization status of the user according to the input identification information, and the control module is further configured to store the copy of the preprocessed file in the cloud server and obtain the determined software in the cloud server to open the copy if the user is determined to be authorized by the authentication module.

4. The system of claim 1, further comprising a display control module, wherein the display control module is executed by the first processor to control the at least one terminal device to display an edit interface on a display unit of the at least one terminal device for the user to edit the copy of the preprocessed file, and the control module is further configured to save the copy of the preprocessed file to the cloud server in response to a save command from the at least one terminal device, and replace the preprocessed file stored in the at least one terminal device with the saved copy.

5. The system of claim 4, wherein the cloud server further comprises a second storage unit for storing a relationship between terminal devices and different operation authority levels of the preprocessed file when at least two terminal devices are coupled with the cloud server, and each terminal device corresponds to one operation authority level of the preprocessed file, the authentication module is further configured to determine an operation authority level of the preprocessed file corresponding to the terminal device, and the control module is further configured to determine whether to save the copy of the preprocessed file according to the determined operation authority level of the preprocessed file.

6. The system of claim 4, further comprising a deleting module, wherein the deleting module is executed by the second processor to delete the copy of the preprocessed file stored in the cloud server when the user closes the preprocessed file.

7. The system of claim 2, further comprising a recording module, wherein the recording module is executed by the second processor to record information comprising a time period of using the determined software in the cloud server and the IP address of the at least one terminal device.

8. A method for managing files among a cloud server and at least one terminal device coupled with the cloud server, each of the at least one terminal device comprising a first storage unit for storing preprocessed files, the method comprising:
determining a type of one preprocessed file when the at least one terminal device receives a request for opening the preprocessed file;
determining a software to open the preprocessed file according to the determined type;
generating a control signal comprising information of the preprocessed file needed to be opened and the determined software to open the preprocessed file; and
transmitting the control signal to the cloud server.

9. The method of claim 8, further comprising:
determining an authorization status of the at least one terminal device in response to the control signal;
storing a copy of the preprocessed file in a buffer of the cloud server if the at least one terminal device is determined to be authorized;
obtaining the determined software in the cloud server according to the control signal; and
controlling the determined software to open the copy of the preprocessed file.

10. The method of claim 9, wherein the control signal comprises an IP address of the at least one terminal device, and the authorization status of the at least one terminal device is determined according to the IP address of the at least one terminal device.

11. The method of claim 9, further comprising:
providing an input interface on a display unit of the at least one terminal device for a user to input identification information if the at least one terminal device is determined to be unauthorized;
determining an authorization status of the user according to the input identification information; and
storing the copy of the preprocessed file in the cloud server and obtaining the determined software in the cloud server to open the copy if the user is determined to be authorized by the authentication module.

12. The method of claim 9, further comprising controlling the at least one terminal device to display an edit interface on a display unit of the at least one terminal device for the user to edit the copy of the preprocessed file;
saving the copy of the preprocessed file to the cloud server in response to a save command from the at least one terminal device; and
replacing the preprocessed file stored in the at least one terminal device with the saved copy.

13. The method of claim 12, wherein the cloud server further comprises a second storage unit for storing a relationship between terminal devices and different operation authority levels of the preprocessed file when at least two terminal devices are coupled with the cloud server, and each terminal device corresponds to one operation authority level of the preprocessed file, the step of saving the copy of the preprocessed file to the cloud server further comprises:
determining an operation authority level of the preprocessed file corresponding to the terminal device; and
determining whether to save the copy of the preprocessed file according to the determined operation authority level of the preprocessed file.

14. The method of claim 12, further comprising:
deleting the copy of the preprocessed file stored in the cloud server when the user closes the preprocessed file.

15. The method of claim 12, further comprising:
recording information comprising a time period of using the determined software in the cloud server and the IP address of the at least one terminal device.
